(19) United States
(12) Patent Application Publication
(10) Pub. No.: US 2024/0054272 A1
(43) Pub. Date: Feb. 15, 2024

(54) INFORMATION PROCESSING APPARATUS, INFORMATION PROCESSING METHOD AND NON-TRANSITORY COMPUTER READABLE MEDIUM

(71) Applicant: KABUSHIKI KAISHA TOSHIBA, Tokyo (JP)

(72) Inventors: Hiro GANGI, Tokyo (JP); Yasunori TAGUCHI, Kawasaki (JP); Hideyuki NAKAGAWA, Kawasaki (JP); Tomoaki INOKUCHI, Yokohama (JP); Yusuke KOBAYASHI, Yokohama (JP); Akihiro GORYU, Kawasaki (JP)

(73) Assignee: KABUSHIKI KAISHA TOSHIBA, Tokyo (JP)

(21) Appl. No.: 18/174,937

(22) Filed: Feb. 27, 2023

(30) Foreign Application Priority Data
Aug. 10, 2022 (JP) 2022-128473

(51) Int. Cl. G06F 30/367

(52) U.S. Cl. CPC G06F 30/367; G06F 2111/10

(57) ABSTRACT

An information processing apparatus according to one embodiment, comprising: a regression model generator configured to, by combining two or more of a plurality of variables, generate a plurality of terms that include combinations of two or more of the plurality of variables, respectively, and generate a regression model that regresses a property variable or an objective variable indicating an output of an objective function that includes the property variable, by the plurality of terms; a subgroup generator configured to generate, based on coefficients of the plurality of terms included in the regression model, subgroups that are the combinations of variables included the terms, respectively; and a subspace search processor configured to perform search for each of subspaces spanned by the subgroups based on an optimization criterion for the objective function, and generate pieces of first design value data that include values of the plurality of variables for the subspaces.

### CROSS REFERENCE TO RELATED APPLICATIONS

This application is based upon and claims the benefit of priority from the prior Japanese Patent Application No. 2022-128473, filed on Aug. 10, 2022, the entire contents of which are incorporated herein by reference.

### FIELD

Embodiments described herein relate to an information processing apparatus, an information processing method and a non-transitory computer readable medium.

### BACKGROUND

In design of an apparatus, it is necessary to optimize design variables for the target apparatus in order to obtain desired properties. However, when there are a plurality of mutually influencing design variables, there is a possibility that a local optimal solution is led to if only adjustment of each design variable one by one is performed. In order to avoid a local optimal solution, it is necessary to, at the time of adjusting each design variable one by one, also consider design variables different from the design variables to be adjusted, and, in some cases, adjust a plurality of design variables at the same time. In such a case, optimization becomes difficult when the number of design variables increases.

To cope with this problem, there is a method called low-dimensional search. In the low-dimensional search, several design variables are selected from among all the design variables first. By performing search only for a low-dimensional subspace spanned by a set (a subgroup) of the design variables, a process for optimizing only the design variables included in the subgroup is performed. When the process ends, another subgroup is generated, and a similar process is performed. By repeating the above process, optimization of all the design variables can be expected. In the low-dimensional search, since the number of variables to be considered at the same time can be reduced, it is possible to efficiently perform optimization of design variables.

In the low-dimensional search, however, selection of a combination of design variables to be subgrouped depends on a designer. There is a problem that, if the combination of design variables included in a subgroup is not appropriate, design variables that mutually interact strongly are independently adjusted. In this case, such a pattern that a property is not improved unless the plurality of design variables are changed at the same time is overlooked, and, therefore, there is a possibility that a local optimal solution is lead to. If design variables of a subgroup are randomly selected, a combination of inappropriate design variables is included, and the number of searches increases. If the number of design variables to be adjusted is increased in order to avoid a local optimal solution being led to, the time cost increases.

### BRIEF DESCRIPTION OF THE DRAWINGS

FIG. 1 is a block diagram of an information processing apparatus according to an embodiment;

FIG. 2 is a partial sectional view exemplifying a structure of a semiconductor apparatus targeted by adjustment of design variables;

FIG. 3 is a diagram showing an example of a table of design variables;

FIG. 4 is a block diagram of a subgroup setter;

FIG. 5 is a diagram showing an example of coefficients of a regression equation;

FIG. 6 is a diagram showing another example of coefficients of a regression equation;

FIG. 7 is a diagram showing a result of sorting the coefficients of the regression equation shown in FIG. 5 in descending order;

FIG. 8 is a diagram showing a result of sorting the coefficients of the regression equation shown in FIG. 6 in descending order;

FIG. 9 is a diagram showing an example of subspaces spanned by subgroups;

FIG. 10 is a diagram showing another example of subspaces spanned by subgroups;

FIG. 11 is a flowchart showing an example of a subgroup generation process;

FIG. 12 is a block diagram showing details of each subspace searcher;

FIG. 13 is a flowchart showing an example of a process executed by each subspace searcher;

FIG. 14 is a flowchart showing an example of a process executed by a subspace search processor;

FIG. 15 is a flowchart showing an example of a process executed by the information processing apparatus according to the embodiment; and

FIG. 16 is a diagram showing a hardware configuration of the information processing apparatus according to the embodiment.

### DETAILED DESCRIPTION

According to one embodiment, an information processing apparatus comprising:
a regression model generator configured to, by combining two or more of a plurality of variables, generate a plurality of terms that include combinations of two or more of the plurality of variables, respectively, and generate a regression model that regresses a property variable or an objective variable by the plurality of terms, the objective variable indicating an output of an objective function that includes the property variable;
a subgroup generator configured to generate, based on coefficients of the plurality of terms included in the regression model, at least one or more subgroups that are one or more of the combinations of variables included in at least one or more of the terms, respectively; and
a subspace search processor configured to perform search for each of subspaces spanned by the subgroups based on an optimization criterion for the objective function, and generate pieces of first design value data that include values of the plurality of variables for the subspaces.

An embodiment of the present invention will be described below with reference to drawings. In the present embodiment, description will be made on a case where, with design variables of a semiconductor apparatus as adjustment targets, optimal values of the design variables are decided, as an example. The target of adjustment of design variables, however, is not limited to a semiconductor apparatus. The target of adjustment of design variables may be, for example, alloy manufacturing conditions, a robot arm control system or the like.

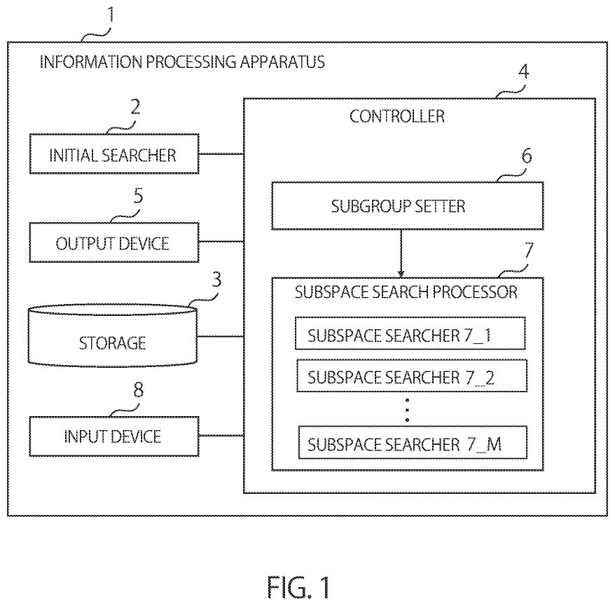

FIG. 1 is a block diagram of an information processing apparatus 1 according to an embodiment. The information processing apparatus 1 searches for optimal, suboptimal or preferable design values that satisfy a desired performance condition, for one or more design variables for a semiconductor apparatus. Search is to find what satisfies constraint conditions and is, in the embodiment, to return highly rated values as design values. A design variable is a variable for a target design value and is, for example, a variable the value of which can be arbitrarily decided by a designer.

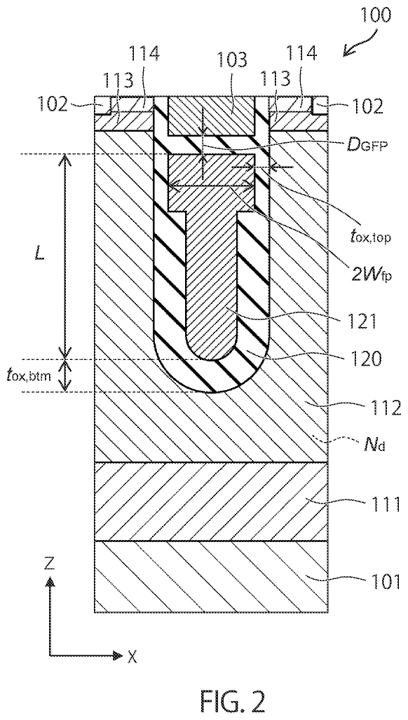

FIG. 2 is a partial sectional view exemplifying a structure of a semiconductor apparatus 100 targeted by adjustment of design variables. The semiconductor apparatus 100 is a MOSFET (metal oxide semiconductor field effect transistor). For convenience of description, an XZ Cartesian coordinate system is adopted. In the Z direction, a direction from a drain electrode 101 to a source electrode 102 is also referred to as “upward”, and a direction opposite to the direction is also referred to as “downward”. These expressions, however, are unrelated to the direction of gravity.

The semiconductor apparatus 100 includes a drain electrode 101, a source electrode 102, a gate electrode 103, a drain layer 111, a drift layer 112, a base layer 113, a source layer 114, a field plate insulating film (an FP insulating film) 120 and a field plate electrode (an FP electrode) 121. For each semiconductor layer, whether the type is to be the p-type or the n-type is optional.

The drain electrode 101, the source electrode 102 and the gate electrode 103 act as a drain electrode, a source electrode and a gate electrode of a MOSFET, respectively. The drain layer 111, the drift layer 112, the base layer 113 and the source layer 114 act as a drain, a drift, a base and a source of the MOSFET, respectively. The FP insulating film 120 electrically insulates the FP electrode 121 from the drift layer 112 and the gate electrode 103. The FP electrode 121 is arranged to relieve concentration of the reverse electric field between the gate electrode 103 and the drain electrode 101 to increase pressure resistance.

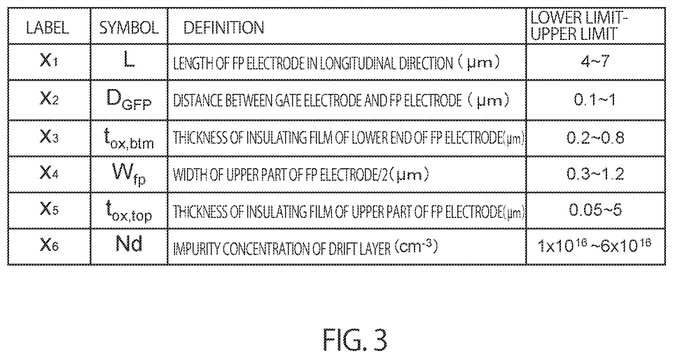

FIG. 3 is a table showing examples of design variables for the semiconductor apparatus 100. By changing N (N≥1) design variables “x”, various performances of the semiconductor apparatus 100 change. Though there are many design variables for the semiconductor apparatus 100, six design variables x₁ to x₆ among them are to be adjusted here (N=6). Design variables to be adjusted may be appropriately changed according to use purposes.

A lower limit and an upper limit, which are design constraints, are provided for each of the design variables x₁ to x₆. The value of a design variable is referred to as a design value. For example, the design value of the design variable x₁ takes an arbitrary value within a range of 4 to 7 (μm). A combination of design values is described as design value data X. The design value data X is expressed by an N-dimensional vector.

Design variables may be, for example, parameters for setting of a manufacturing apparatus. Further, design variables may be continuous variables, discrete variables or category variables.

Here, a variable indicating a property of the semiconductor apparatus 100 is referred to as a property variable (or an intermediate result) and indicated by yₖ. There are one or more property variables yₖ (k≥1). The property variable yₖ is, for example, ON resistance, pressure resistance, a switching charge or the like of the MOSFET.

In the present embodiment, a function targeted by optimization is indicated by an objective function “f” (see Formula (1) described later). The objective function “f” is made using one or more property variables yₖ. The objective function “f” is set in advance by a user.

The information processing apparatus 1 in FIG. 1 is provided with an initial searcher 2, a storage 3, a controller 4, an output device 5 and an input device 8.

The initial searcher 2 performs sampling of values of the plurality of design variables (initial sampling) as initial search. The initial searcher 2 performs the initial sampling by inputting pieces of design value data X that include randomly generated values of the plurality of design variables, respectively, to a simulator and acquiring an output value “g” of the property variable yₖ (called an observed value of the property variable yₖ), an output value “h” of the objective function “f” (called an observed value of the objective function “f”) or both of them. In a case where the property variable yₖ is indicated by a function that includes a design variable, the observed value of the property variable yₖ may be acquired by inputting design value data to the function. Or alternatively, as a method for acquiring the observed values, the initial searcher 2 may acquire the obtained observed values based on simulation performed by the user, or an external apparatus or the like and/or experiments and the like.

A combination of one piece of design value data X and observed values corresponding thereto {X,g,h} is assumed as a data set D. The initial searcher 2 stores data sets D obtained by the initial sampling into the storage 3. There are one or more observed values “g” of the property variable yₖ. For example, if there are property variables y₁ and y₂, observed values g₁ and g₂ are outputted, and the data sets D are indicated by {X,g₁,g₂,h}. In this case, the initial searcher 2 stores the data sets D {X,g₁,g₂,h} that include a plurality of combinations of design value data X, and the observed values {g₁,g₂,h} into the storage 3.

In the case of acquiring only either the observed value “h” of the objective function “f” or the observed value “g” of the property variable yₖ, only either the observed value “h” of the objective function “f” or the observed value “g” of the property variable yₖ may be included in the data sets D. The observed value of the property variable yₖ or the observed value of the objective function “f” obtained based on simulation and/or experiments and the like can include a noise component.

In the present embodiment, design is performed with attention being paid to pressure resistance y₁ and ON resistance y₂ as the property variables yₖ. For example, such a structure of a semiconductor apparatus that “pressure resistance (V_{dss}) is 110 V or more” and “ON resistance per unit area (RonA) is minimized”, that is, values of design variables for the semiconductor apparatus are searched for. The objective function “f” at this time is expressed, for example, like Formula 1 using a ramp function ReLU. The objective function “f” is determined in advance by the user. In the present embodiment, description will be made on an example of determining design variables that minimize or semi-minimize an output variable (an objective variable) indicating an output of the objective function “f” as an optimization criterion for the objective function “f”. By reversing the sign of the objective function “f”, an objective function minimization problem can be rewritten to an equivalent maximization problem. Description of the case of performing maximization will be omitted.

[Formula 1]

f=RonA/30+10 ReLU(110−V_{dss}) (1)

From Formula 1, it is seen that, when the objective function “f” is minimized, “RonA being the minimum” is satisfied while “V_{dss} being 110 V or more” is satisfied. Here, “110” is a target value of V_{dss}. In Formula 1, the coefficients “1/30” and “10” attached to the property variables are values that are appropriately set by the user. Each property variable yₖ may be normalized to unify the scale. By inputting the observed values “g” of the property variables (the observed values of RonA and V_{dss}) to Formula 1, the observed value “h” of the objective function “f” can be obtained.

The storage 3 stores the data sets D generated by the initial searcher 2. The data sets D in the storage 3 are updated by data being added by a subspace search processor 7 be described later. The storage 3 is configured with a storage medium, for example, a RAM (random access memory), a flash memory or an optical disc.

The controller 4 is provided with a subgroup setter 6 that combines a plurality of design variables to generate a plurality of (M) subgroups, which are combinations of two or more design variables, and the subspace search processor 7. The subspace search processor 7 is provided with a plurality of subspace searchers 7_1 to 7_M corresponding to a plurality of subspaces spanned by the plurality of subgroups. One subspace is spanned by one subgroup. Each of the initial searcher 2 and the controller 4 can be configured, for example, with processors or circuits such as CPUs, MPUs or ASICs.

The output device 5 outputs various kinds of information or data generated by processing by the controller 4. The output device 5 is, for example, a liquid crystal display, an organic electroluminescence display, an LED (light emitting diode) display or another type of user interface capable of displaying data. The output device 5 may be a printer that prints data on paper or a transmitter that wirelessly or wiredly transmits data.

The input device 8 receives input from the user of various kinds of information (user set values) required for processing by the initial searcher 2 and the controller 4. The user set values may include, for example, an objective function expression, a design value to be a starting point of initial sampling performed by the initial searcher 2, the number of subgroups to be generated by a subgroup generator 64 described later, the number of search processes executed by a subspace searcher 7_n described later, a termination condition described later and the like.

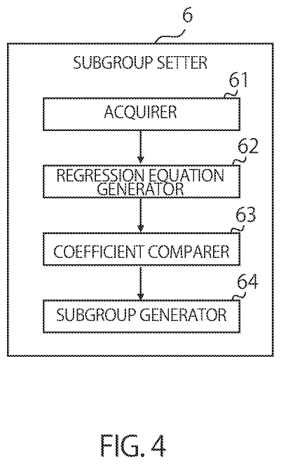

FIG. 4 is a block diagram of the subgroup setter 6. The subgroup setter 6 is provided with an acquirer 61, a regression equation generator 62 (a regression model generator), a coefficient comparer 63 and a subgroup generator 64.

The acquirer 61 acquires the data sets D from the storage 3.

The regression equation generator 62 generates a regression equation f′ with the design variables as a regression model that regresses an output variable (an objective variable) of the objective function “f”, based on the acquired data sets D. Or alternatively, the regression equation generator 62 generates, for each property variable yₖ, a regression equation yₖ′ that regresses the property variable yₖ with a group of design variables (a property variable regression equation), based on the acquired data sets D.

Which regression equation is to be generated may be set by the user in advance, or a screen for causing the user to select which regression equation is to be generated may be presented to cause the user to select it. For example, if judging that a more accurate regression equation can be generated by generating a regression equation yₖ′ for each property variable yₖ, the user may select to generate the property variable regression equation. Or alternatively, which regression equation is to be generated may be decided in advance according to the types of a plurality of property variables yₖ included in the objective function “f”.

An example of generating a regression equation will be shown below, mainly focusing on a case where the regression equation generator 62 generates a regression equation yₖ′ for each of the two property variables, the ON resistance per unit area RonA and the pressure resistance V_{dss}.

The regression equation generator 62 generates a plurality of explanatory variables x′ for the regression equation yₖ′. Each of the explanatory variables x′ is a term indicating a design variable “x” itself (a design variable term) or a term that includes a combination of a plurality of (two or more) design variables “x”. Hereinafter, the term that includes a combination of a plurality of design variables “x” will be referred to as “an interaction term”.

An example of the regression equation yₖ′ generated by the regression equation generator 62 is shown by Formula 2. The regression equation f′ can be also expressed by a formula similar to Formula 2.

Here, “c” is a coefficient (a weight). As shown in Formula 2, the regression equation yₖ′ includes terms of design variable themselves and interaction terms. Here, each interaction term is a product of two design variables. There are six design variables x₁ to x₆, and ₆C₂=15 interaction terms, which are all of combinations of two design variables, are included.

[Formula 2]

yₖ′(x)=c₀+c₁x₁+c₂x₂+c₃x₃+c₄x₄+c₅x₅+c₆x₆+(interaction terms) (2)
(interaction terms)=c₁₂x₁x₂+c₁₃x₁x₃+ . . . +c₅₆x₆x₆

An interaction term may include a product of three or more design variables. An interaction term may include reciprocals of design variables or a product of reciprocals. Or alternatively, an interaction term may include a compound function of design variables.

The regression equation generator 62 may calculate a decision coefficient R² by taking a correlation between a value obtained by inputting design value data included in the data sets D to the generated regression equation yₖ′ (a predicted value) and observed values of the property variables yₖ included in the data sets D. In the case of generating the regression equation for an objective variable, observed values of the objective function “f” can be used as the observed values included in the data sets D.

As for the type of regression used by the regression equation generator 62, any type of regression may be used if an interaction term and a coefficient (a weight) are provided. The regression equation generator 62 may generate a regression model using at least one of ridge regression, lasso regression, elastic net regression, decision tree regression, random forest regression, K-proximity regression, support vector regression and a neural network. In the random forest regression, a coefficient corresponds to feature importance. Further, permutation importance may be used as a coefficient “c”.

The coefficient comparer 63 decides a combination of two or more design variables that mutually interact strongly, based on coefficients of interaction terms included in the generated regression equation yₖ′ (or f′). For example, the coefficient comparer 63 decides the combination of two or more design variables that mutually interact strongly, based on magnitudes (absolute values) of the coefficients of the interaction terms. When the absolute value of a coefficient of an interaction term is larger, it means that interaction among two or more design variables included in the interaction term is stronger.

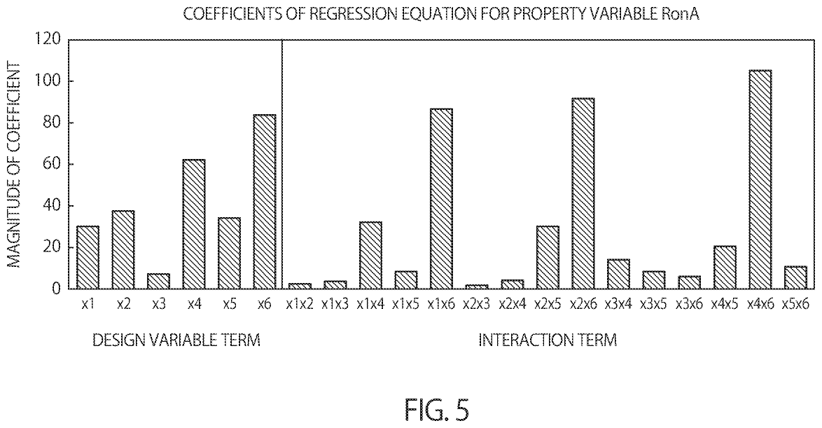

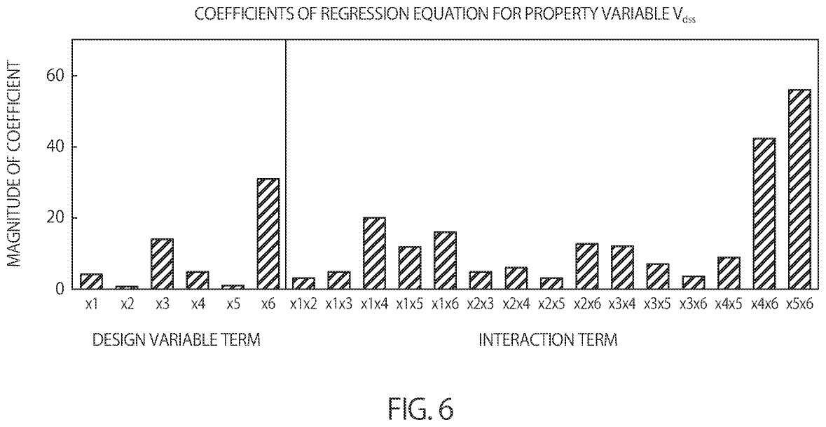

FIGS. 5 and 6 are graphs of coefficients “c” of terms that the coefficient comparer 63 has extracted based on the generated regression equations yₖ′. The vertical axis of FIGS. 5 and 6 indicates the magnitude (the absolute value) of the coefficients “c”. FIG. 5 is a graph of extraction of coefficients for the property variable RonA included in the objective function “f” shown in Formula 1. FIG. 6 is a graph of extraction of coefficients for the property variable V_{dss} included in the objective function “f” shown in Formula 1. In the examples of FIGS. 5 and 6, a regression equation yₖ′ is generated for each property variable.

The output device 5 may output the generated regression equations yₖ′ or information about the regression equations yₖ′ to cause the user to confirm the equation or the information. For example, the output device 5 may output such coefficients of terms extracted by the coefficient comparer 63 that are shown in FIGS. 5 and 6 to cause the user to confirm them. Or alternatively, the output device 5 may output decision coefficients R² of the generated regression equations yₖ′, which have been calculated by the regression equation generator 62. Thereby, the user can easily grasp the content and accuracy of the generated regression equations yₖ′.

The subgroup generator 64 selects at least one interaction term based on coefficients of interaction terms and generates at least one subgroup, which is a combination of design variables included into the selected interaction term. For example, the subgroup generator 64 performs sorting of the interaction terms in descending order of the absolute values of coefficients and collection of a plurality of design variables included in each interaction term into one subgroup in order of being sorted until all design variables are included in at least one subgroup. This subgrouping process is performed for each property variable yₖ.

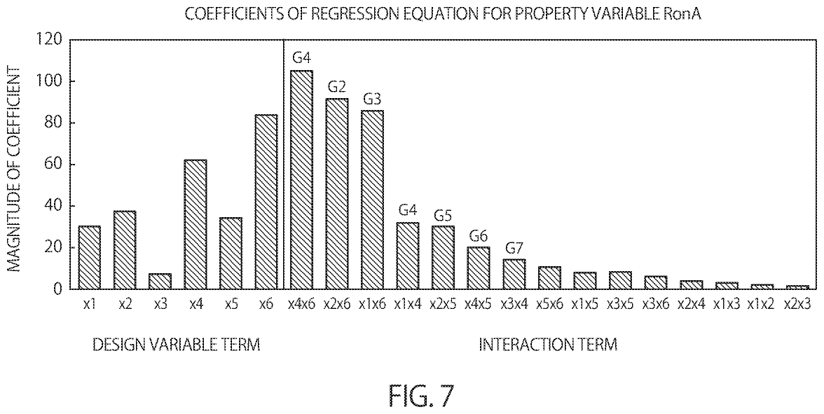

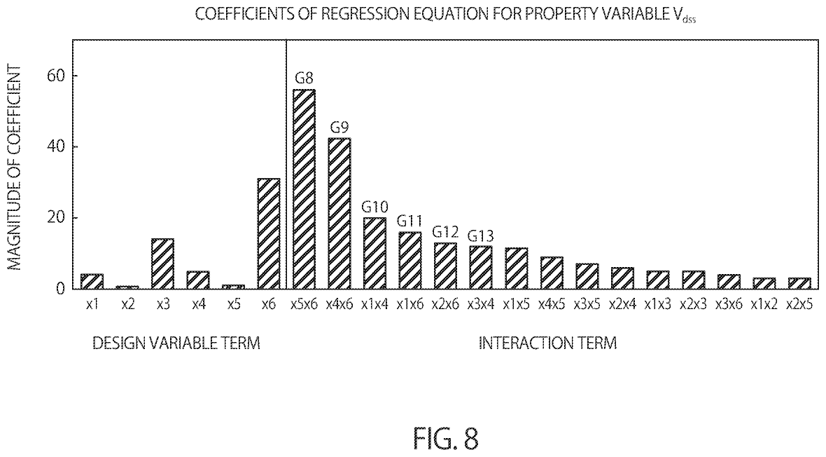

FIGS. 7 and 8 show a result of sorting the interaction terms shown in FIGS. 5 and 6 in descending order of the absolute values of the coefficients of the interaction terms, respectively. For example, referring to FIG. 7, an interaction term with the largest coefficient is a term x₄x₆, and x₂x₆, x₁x₆, . . . follow the term x₄x₆ in that order.

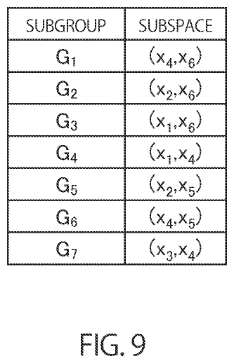

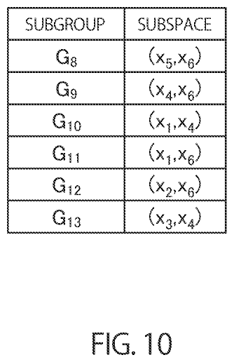

FIGS. 9 and 10 show examples of subgroups generated by the subgroup generator 64 and subspaces spanned by the subgroups in the case of the sort results of FIGS. 7 and 8, respectively. In the present embodiment, first, for the property variable “RonA”, the subgroup generator 64 selects interaction terms in descending order of coefficients as shown in FIG. 7, and generates subgroups, which are combinations of design variables included in the selected interaction terms, like G₁, G₂, . . . shown in FIG. 9. The subgroup generator 64 performs the generation of subgroups, for example, until each of all the design variables is included in at least any subgroup. In the present embodiment, when a subgroup G₇ is generated, each of all the design variables is included in at least one subgroup, and, therefore, the generation of subgroups is ended.

The subgroup generator 64 also generates subgroups for the property variable V_{dss} similarly. That is, the subgroup generator 64 selects interaction terms in descending order of coefficients as shown in FIG. 8, and generates subgroups, which are combinations of design variables included in the selected interaction terms, like G₈, G₉, . . . shown in FIG. 10. In the present embodiment, when a subgroup G₁₃ is generated, each of all the design variables is included in at least one subgroup, and, therefore, the generation of subgroups is ended.

Thus, a total of thirteen subgroups G₁ to G₁₃ are generated for the property variable RonA and the property variable V_{dss}.

The subgroup generator 64 may generate the subgroups for the property variable V_{dss} first. Further, the subgroup generator 64 may generate the same number of subgroups for each of a plurality of property variables. In this case, for example, according to the number of subgroups of a property variable with the largest number of subgroups, subgroups of the other property variables may be generated. Further, the subgroup generator 64 may generate the number of subgroups based on a user set value inputted in advance.

As an example, it is desirable that the number of design variable included in a subgroup is two or three. That is, it is desirable that the number of design variable included in each interaction term included in each regression equation generated by the regression equation generator 62 is two or more. However, it is not excluded that four or more design variables are included in an interaction term.

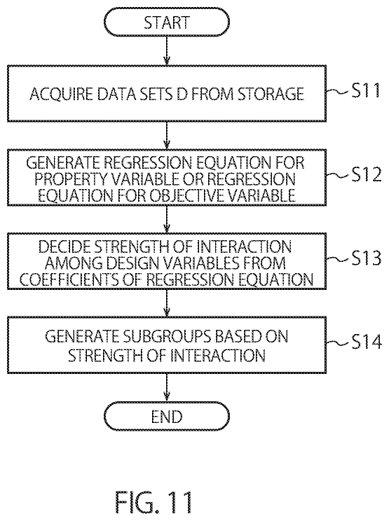

FIG. 11 is a flowchart showing an example of the subgroup generation process executed by the subgroup setter 6.

First, the acquirer 61 acquires the data sets D stored in the storage 3 (step S11).

Next, the regression equation generator 62 generates the regression equations yₖ′ for the property variables yₖ or the regression equation f′ for the objective variable based on a part or all of the data sets D acquired by the acquirer 61 (step S12). In the description below about the present flowchart, the case of generating the regression equations yₖ′ for the property variables yₖ will be described.

Next, based on the coefficients of the interaction terms included in each of the generated regression equations yₖ′ for the property variables yₖ, the coefficient comparer 63 decides strength of interaction among design variables for each interaction term (step S13).

Next, the subgroup generator 64 performs collection of design variables included in each interaction term into one subgroup in descending order of interaction strength until each of all the design variables is included in at least one subgroup (step S14).

The process of steps S12 to S14 is performed for each property variable yₖ. For example, a plurality of first subgroups are generated for a first property variable, and a plurality of second subgroups are generated for a second property variable. For the first and second property variables, a plurality of subgroups corresponding to a total of the number of the first subgroups and the number of the second subgroups are generated.

Hereinafter, the n-the subgroup among the M subgroups will be referred to as a subgroup Gₙ (n≥1). A subspace spanned by the subgroup Gₙ will be referred to as a subspace Vₙ (n≥1).

When a plurality of subgroups are generated by the subgroup setter 6, the subspace search processor 7 of the controller 4 performs a subspace search process for each of subspaces spanned by the generated subgroups in order. The search process is performed by the subspace searchers 7_N (N=1 to M) for the subspaces, respectively.

After the plurality of subgroups are generated by the subgroup setter 6, one subspace searcher acquires one subgroup among the plurality of generated subgroups. Then, the subspace searcher generates one subspace from the acquired one subgroup and searches the subgroup.

Hereinafter, the n-th subspace searcher that generates a subspace Vₙ from the subgroup Gₙ and searches the subspace Vₙ will be referred to as a subspace searcher 7_n. Hereinafter, description will be made with attention being paid to the subspace searcher 7_n.

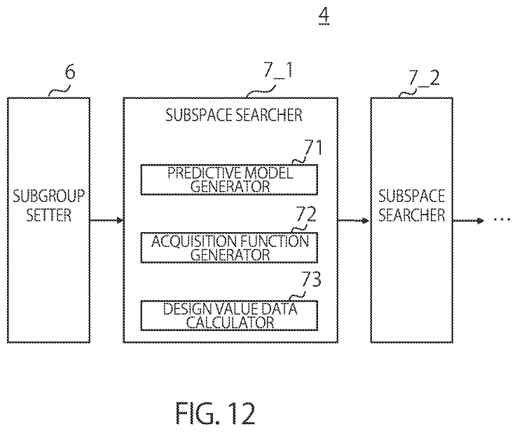

FIG. 12 is a block diagram showing details of the subspace searcher 7_n (FIG. 12 shows the case of n=1). Search of the subspace Vₙ is performed by the subspace searcher 7_n in a direction in which the observed value of the objective function “f” decreases. That is, values of design variables that minimize or sub-minimize the value of the objective function “f” are searched for.

As shown in FIG. 12, the subspace searcher 7_n is provided with a predictive model generator 71, an acquisition function generator 72 and a design value data calculator 73. The other subspace searchers have components equal to those components. The subspace searcher 7_n searches for design values that minimize or semi-minimize the value (the observed value) of the objective function “f” in the subspace Vₙ using the data sets D stored in the storage 3 and the objective function “f” and acquires data X that includes the searched design values. At the time of the search, arbitrary values are decided for values of design variables other than design variables that span the subspace Vₙ, and the subspace Vₙ is searched, with the other design variable being fixed to the decided values. The data X includes the searched values of the design variables that span the subspace Vₙ and the values of the other design variable for which the arbitrary values are decided. This will be described in more detail below.

The predictive model generator 71 generates a predictive model (a surrogate model) for the value of the objective function “f” in the subspace Vₙ, for example, using Gaussian process regression, based on a part or all of the data sets D stored in the storage 3.

More specifically, for example, with the design variables that do not span the search target subspace Vₙ being fixed to arbitrary values, and, with the design variables that span the search target subspace Vₙ being set as model variables, the predictive model (the surrogate model) for the value of the objective function “f” is generated by the Gaussian process regression. For example, when a subspace V₁ is a search target, the surrogate model is a function of x₄ and x₆. The values of the design variables to be fixed because of not spanning the search target subspace Vₙ may be, for example, values of the design variables to be fixed which are included in design value data that gives the smallest (optimal) observed value “g” or observed value “h” among observed values included in the data sets D stored in the storage 3.

The acquisition function generator 72 generates an acquisition function by Bayesian estimation, based on the predictive model generated by the predictive model generator 71. For example, the acquisition function generator 72 calculates a mean and a standard deviation of predictive distribution of values of the objective function “f” corresponding to values of the design variables included in the subgroup that spans the search target subspace Vₙ, and calculates an acquisition function based on the mean and the standard deviation. The acquisition function generated by the acquisition function generator 72 is, for example, PI (probability of improvement), EI (expected improvement), UCB (upper confidence bound) or the like. For example, the EI is a function with an expected value of a difference between an evaluated value of the predictive model and the best value at the time of evaluation (an expected value of an amount of improvement) as an objective variable. Hereinafter, description will be made on the assumption that, the larger the acquisition function for a certain design value is, the higher the evaluation of the design value is.

The design value data calculator 73 decides such values that maximize or semi-maximize the acquisition function for the design variables spanning the search target subspace Vₙ. The values that maximize or semi-maximize the acquisition function are decided as design values that are highly likely minimize or semi-minimize the observed value of the objective function “f”. The design value data calculator 73 determines the design variables that maximize or semi-maximize the acquisition function, for example, using full search, random search, grid search, Newton's method or the like.

The design value data calculator 73 acquires observed values of the property variables yₖ (or an observed value of the objective function “f”) from design value data that includes the design values decided for the design variables that span the search target subspace Vₙ and the above-described fixed values for the design variables that do not span the search target subspace. A method for acquiring the observed values may be similar to that of the initial searcher 2. The design value data calculator 73 adds data that includes the design value data and the acquired observed values to the data sets D in the storage 3.

For the search target subspace Vₙ, the subspace searcher 7_n performs the series of search processes performed by the predictive model generator 71 to the design value data calculator 73 described above a predetermined number of times (for example, ten times). The number of times the subspace searcher 7_n executes the search process may be based on a user set value inputted in advance. Since data is added to the data set D each time the process is performed, the content of the data set D targeted by the predictive model generator 71 increases by one piece of data each time. In this way, search for values of the design variables that span the subspace Vₙ is repeatedly performed.

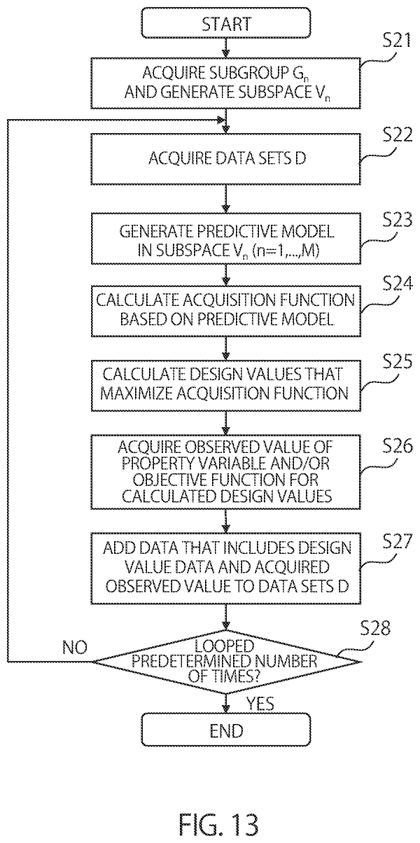

FIG. 13 is a flowchart showing an example of the process executed by the subspace searcher 7_n corresponding to the search target subspace Vₙ.

First, the subspace searcher 7_n acquires a subgroup Gₙ from among a plurality of subgroups generated by the subgroup setter 6 and generates the subspace Vₙ (step S21).

Next, the subspace searcher 7_n acquires the data sets D stored in the storage 3 (step S22).

Next, the predictive model generator 71 generates a predictive model for the value of the objective function “f” within the subspace Vₙ based on the acquired data sets D (step S23). The predictive model is a function with design variables that span the search target subspace Vₙ as model variables. At this time, for design variables that do not span the search target subspace Vₙ, the predictive model generator 71 decides arbitrary values.

Next, the acquisition function generator 72 generates an acquisition function based on the generated predictive model (step S24).

Next, for the design variables that span the search target subspace Vₙ, the design value data calculator 73 decides design values that maximize or semi-maximize the acquisition function (step S25).

Next, the design value data calculator 73 acquires observed values of the property variables yₖ and/or the objective function “f” for design value data that includes the decided values of the design variables that span the search target subspace Vₙ and the arbitrarily decided values of the design variables that do not span the search target subspace Vₙ (step S26).

The design value data calculator 73 adds data that includes the design value data and the acquired observed values to the data sets D in the storage 3 (step S27).

Next, the subspace searcher 7_n judges whether steps S22 to S27 have been repeated a predetermined number of times or not (step S28).

If it is judged that steps S22 to S27 have not been repeated the predetermined number of times (step S28: No), the subspace searcher 7_n returns to step S22.

If it is judged that steps S22 to S27 have been repeated the predetermined number of times (step S28: Yes), the process is ended.

By performing the above process, search of the subspace Vₙ is performed. When the search of the subspace Vₙ is completed, search of a subspace Vₙ-ki is performed by the next subspace searcher 7_n+1. At this time, the subspace searcher 7_n+1 performs search of the subspace Vₙ+1 based on the data sets D on which the search of the previous subspaces V₁ to Vₙ is reflected.

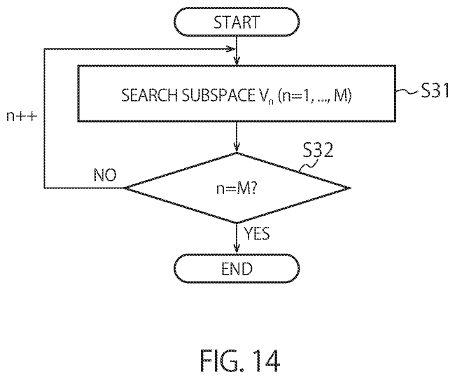

FIG. 14 is a flowchart showing an example of a process executed by the subspace search processor 7.

First, on the assumption of n=1, the subspace searcher 7_n performs search a predetermined number of times for a subspace Vₙ, based on a part or all of the data sets D stored in the storage 3 (step S31). The subspace searcher 7_n adds data that includes design value data based on a result of the search and observed values corresponding to the design value data to the data sets D in the storage 3. Step S31 includes steps S21 to S28 of FIG. 13.

Next, the subspace search processor 7 judges whether search has been performed for all the M subspaces or not (step S32).

If search has not been performed for all the M subspaces (step S32: No), the subspace search processor 7 returns to step S31, where the next subspace searcher 7_n+1 performs search of a subspace Vₙ+1.

If search has been performed for all the M subspaces (step S32: Yes), the process is ended. By the above process, search is performed for all the generated subspaces.

After that, the controller 4 may decide values of a plurality of design variables included in such design value data that the observed value of the objective function “f” is the smallest among the data sets D, as values of design variables for the semiconductor apparatus 100. The controller 4 may output information showing the decided values of the design variables to the user via the output device 5.

The series of processes by the subgroup setter 6 and the subspace search processor 7 (the subgroup setting/subspace search processes) described above may be performed a plurality of times. That is, when the series of processes of the subgroup setter 6 generating subgroups and the subspace search processor 7 generating subspaces by all the generated subgroups and performing search for all the subspaces (the subgroup setting/subspace search processes) is assumed as one round, the series of processes may be repeated two or more rounds.

In this case, for the second and subsequent rounds, the subgroup setter 6 generates subgroups again, and the search process by the subspace search processor 7 is started. At this time, unlike the first round, the regression equation generator 62 of the subgroup setter 6 generates a regression equation based on the data sets D on which the previous processes are reflected. Since the number of pieces of data of the data sets D referred to at the time of generating a regression equation increases with each repetition, it can be expected that the accuracy of a regression equation generated by the regression equation generator 62 increases. That is, it is possible to generate subgroups thought to be effective for further decreasing the value of the objective function “f”.

The controller 4 repeats the subgroup setting/subspace search processes until a termination condition is satisfied. For example, the controller 4 may repeat the subgroup setting/subspace search processes until a predetermined number of rounds is reached or until the amount of time required for the processes reaches a predetermined amount of time. Or alternatively, the controller 4 may repeat the subgroup setting/subspace search processes until the decision coefficient R 2 calculated by the regression equation generator 62 is equal to or larger than a predetermined threshold. Or alternatively, the controller 4 may repeat the subgroup setting/subspace search processes until the observed value of the objective function “f” based on design value data obtained as a result of search by the subspace search processor 7 reaches a predetermined value. The controller 4 may set the termination condition by combining a plurality of conditions. The controller 4 may set the termination condition based on a user set value inputted in advance.

For the second and subsequent rounds, the subgroup generator 64 may increase or decrease the number of subgroups to be generated as the number of rounds increases. Or alternatively, the subgroup generator 64 may change the number of subgroups to be generated when the number of rounds reaches a predetermined number of times (that is, the number of subgroups to be generated is not changed before the number of rounds reaches the predetermined number of times).

Further, the regression equation generator 62 may change the configuration of each interaction term according to the number of rounds. For example, each interaction term may include a product of two different design variables for the first round and a product of three different design variables for the second round.

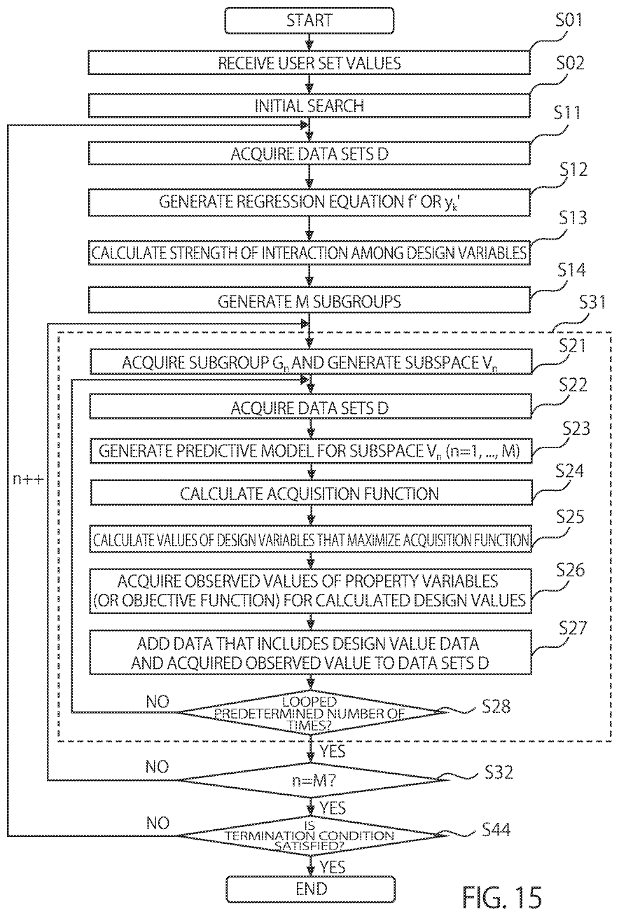

FIG. 15 is a flowchart showing an example of the whole process executed by the information processing apparatus 1. Since steps S11 to S14 are the same as those of the flowchart of FIG. 11, and steps S21 to S28 are the same as those of the flowchart of FIG. 13, description will be simply made.

First, the input device 8 receives input of various user set values by the user (step S01).

Next, as initial search, the initial searcher 2 performs sampling of design value data and acquisition of observed values (observed values of the property variables yₖ, an observed value of the objective function “f” or both of them) based on each piece of sampled design value data (step S02). The initial searcher 2 stores a plurality of pieces of data that include the obtained pieces of design value data and observed values into the storage 3 as data sets D.

Next, the acquirer 61 acquires the data sets D stored in the storage 3 (step S11).

Next, the regression equation generator 62 generates the regression equations yₖ′ for the property variables yₖ or the regression equation f′ for an output of the objective function “f” (an objective variable) based on a part or all of the data sets D acquired by the acquirer 61 (step S12).

Next, based on the coefficient of each interaction term included in the regression equation, the coefficient comparer 63 decides strength of interaction among design variables included in the interaction term (step S13).

Next, the subgroup generator 64 selects interaction terms in descending order of strength of interaction among design variables and generates a plurality of (M) subgroups by subgrouping design variables included in each of the selected interaction terms (step S14).

Next, the subspace searcher 7_n acquires a subgroup Gₙ from among the M subgroups and generates a subspace Vₙ (n=1 to M) (step S21).

Next, the subspace searcher 7_n acquires the data sets D stored in the storage 3 (step S22).

Next, the predictive model generator 71 generates a predictive model (a surrogate model) for the value of the objective function “f” for the subspace Vₙ based on the acquired data sets D (step S23).

Next, the acquisition function generator 72 calculates an acquisition function based on the generated predictive model (step S24).

Next, for the subspace Vₙ, the design value data calculator 73 decides values of design variables that maximize or semi-maximize the acquisition function and decides design value data that includes the decided values of the design variables (step S25).

Next, the design value data calculator 73 acquires observed values (the observed values of the property variables yₖ, the observed value of the objective function “f” or both of them) based on the decided design value data (step S26).

Next, the design value data calculator 73 adds data that includes the decided design value data and the acquired observed values to the data sets D in the storage 3 (step S27).

Next, for the subspace Vₙ, the subspace search processor 7 judges whether steps S22 to S27 have been repeated a predetermined number of times or not (step S28).

If it is judged that steps S22 to S27 have not been repeated the predetermined number of times (step S28: NO), the subspace search processor 7 returns to step S21.

If it is judged that steps S22 to S27 have been repeated the predetermined number of times (step S28: YES), the subspace search processor 7 judges whether search has been performed for all the M subspaces (step S32).

If search has not been performed for all the M subspaces (step S32: NO), the subspace search processor 7 returns to step S21, where the next subspace searcher 7_n+1 performs search of a subspace V_{n+1.}

If search has been performed for all the M subspaces (step S32: Yes), the controller 4 judges whether a termination condition is satisfied or not (step S44).

If the termination condition is not satisfied (step S44: No), the controller 4 returns to step S11.

If the termination condition is satisfied (step S44: Yes), the controller 4 ends the process.

According to the present embodiment, it is possible to, by generating subgroups of design variables using regression, efficiently generate subgroups of design variable with strong interaction. Thereby, it becomes possible to efficiently determine values of design variables that cause an observed value of the objective function “f” to be optimal or suboptimal. Further, by repeating subgroup setting/subspace search processes a plurality of times, effective data is accumulated as data sets D, and, therefore, more effective subgroups can be generated. As a result, it is possible to reduce the possibility of being led to a local optimal solution and efficiently perform optimization of all the design variables.

### (Hardware Configuration)

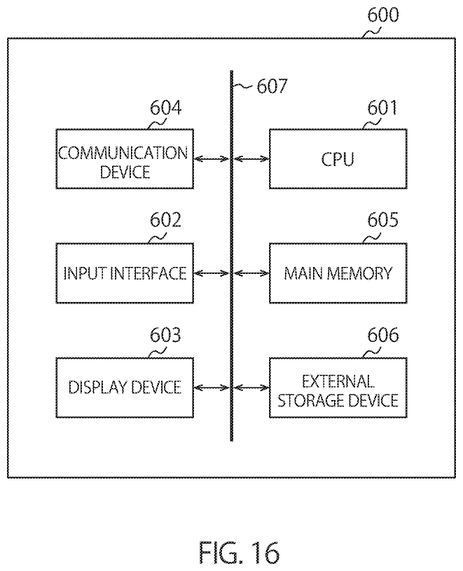

FIG. 16 illustrates a hardware configuration of the information processing device according to each embodiment. The information processing device is configured as a computer device 600. The computer device 600 includes a CPU 601, an input interface 602, a display device 603, a communication device 604, a main storage device 605, and an external storage device 606, and these components are mutually connected through a bus 607.

The CPU (central processing unit) 601 executes an information processing program as a computer program on the main storage device 605. The information processing program is a computer program configured to achieve each above-described functional composition of the present device. The information processing program may be achieved by a combination of a plurality of computer programs and scripts instead of one computer program. Each functional composition is achieved as the CPU 601 executes the information processing program.

The input interface 602 is a circuit for inputting, to the present device, an operation signal from an input device such as a keyboard, a mouse, or a touch panel. The input interface 602 corresponds to the input device in each embodiment.

The display device 603 displays data output from the present device. The display device 603 is, for example, a liquid crystal display (LCD), an organic electroluminescence display, a cathode-ray tube (CRT), or a plasma display (PDP) but is not limited thereto. Data output from the computer device 600 can be displayed on the display device 603. The display device 603 corresponds to the output device in each embodiment.

The communication device 604 is a circuit for the present device to communicate with an external device in a wireless or wired manner. Data can be input from the external device through the communication device 604. The data input from the external device can be stored in the main storage device 605 or the external storage device 606.

The main storage device 605 stores, for example, the information processing program, data necessary for execution of the information processing program, and data generated through execution of the information processing program. The information processing program is loaded and executed on the main storage device 605. The main storage device 605 is, for example, a RAM, a DRAM, or an SRAM but is not limited thereto. Each storage or database in the information processing device in each embodiment may be implemented on the main storage device 605.

The external storage device 606 stores, for example, the information processing program, data necessary for execution of the information processing program, and data generated through execution of the information processing program. The information processing program and the data are read onto the main storage device 605 at execution of the information processing program. The external storage device 606 is, for example, a hard disk, an optical disk, a flash memory, or a magnetic tape but is not limited thereto. Each storage or database in the information processing device in each embodiment may be implemented on the external storage device 606.

The information processing program may be installed on the computer device 600 in advance or may be stored in a storage medium such as a CD-ROM. Moreover, the information processing program in each embodiment may be uploaded on the Internet.

The present device may be configured as a single computer device 600 or may be configured as a system including a plurality of mutually connected computer devices 600.

While certain embodiment have been described, these embodiment have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### Clauses

Clause 1. An information processing apparatus comprising:
a regression model generator configured to, by combining two or more of a plurality of variables, generate a plurality of terms that include combinations of two or more of the plurality of variables, respectively, and generate a regression model that regresses a property variable or an objective variable by the plurality of terms, the objective variable indicating an output of an objective function that includes the property variable;
a subgroup generator configured to generate, based on coefficients of the plurality of terms included in the regression model, at least one or more subgroups that are one or more of the combinations of variables included in at least one or more of the terms, respectively; and
a subspace search processor configured to perform search for each of subspaces spanned by the subgroups based on an optimization criterion for the objective function, and generate pieces of first design value data that include values of the plurality of variables for the subspaces.
   Clause 2. The information processing apparatus according to clause 1, wherein the regression model generator generates the regression model based on data sets, the data sets including pieces of second design value data that include values of the plurality of variables acquired by sampling, respectively, and output values of the property variable or output values of the objective function based on the pieces of second design value data, respectively.
   Clause 3. The information processing apparatus according to clause 1 or 2, wherein the subgroup generator performs selection of the terms in descending order of absolute values of the coefficients and generation of the subgroups that are the combinations of variables included in the terms in order of selection until the plurality of variables are included in at least any of the subgroups.
   Clause 4. The information processing apparatus according to any one of clauses 1 to 3, wherein the subspace search processor searches the subspaces in descending order of the absolute values of the coefficients.
   Clause 5. The information processing apparatus according to any one of clauses 1 to 4, wherein each of the terms includes at least one of a product of the variables, reciprocals of the variables, a product of the reciprocals of the variables and a compound function of the variables.
   Clause 6. The information processing apparatus according to any one of clauses 1 to 5, wherein the regression model generator generates the regression model using at least one of ridge regression, lasso regression, elastic net regression, decision tree regression, random forest regression, K-proximity regression, support vector regression and a neural network.
   Clause 7. The information processing apparatus according to clause 2, wherein
the subspace search processor decides for values of variables other than the variables that span the subspaces among the plurality of variables wherein the decided values are any of the pieces of first design value data or any of the pieces of second design value data that gives an optimal output value of the property variable or the objective function among the output values included in the data sets,
generates the pieces of first design value data that include
   the values of the variables acquired by the search and
   the value of the other variables, respectively, and
adds, to the data sets, pieces of data that include
   the pieces of first design value data and
   values of the property variable or output values of the objective variable based on the pieces of first design value data.
      Clause 8. The information processing apparatus according to clause 7, wherein the subspace search processor searches a space spanned by any of the subgroups that has the next largest coefficient absolute value based on the data sets to which the pieces of data are added.
      Clause 9. The information processing apparatus according to clause 7 or 8, wherein the subspace search processor continuously performs search of the subspace a plurality of times.
      Clause 10. The information processing apparatus according to any one of clauses 7 to 9, wherein, after the search for all the subspaces ends, a series of the processes by the regression model generator, the subgroup generator and the subspace search processor is repeated one or more times based on the data sets.
      Clause 11. The information processing apparatus according to clause 10, wherein the subgroup generator increases the number of the subgroups to be generated as the number of repetitions of the series of the processes increases.
      Clause 12. The information processing apparatus according to claim 10, wherein the subgroup generator decreases the number of the subgroups to be generated as the number of repetitions of the series of the processes increases.
      Clause 13. The information processing apparatus according to clause 10, wherein the subgroup generator changes the number of the subgroups to be generated when the number of repetitions of the series of the processes reaches a predetermined number of times.
      Clause 14. The information processing apparatus according to any one of clauses 1 to 13, further comprising an output device configured to output information about the terms and the coefficients of the terms that are included in the regression model.
      Clause 15. The information processing apparatus according to any one of clauses 1 to 14, wherein a target apparatus is a semiconductor apparatus.
      Clause 16. An information processing method comprising:
combining two or more of a plurality of variables and generating a plurality of terms that include combinations of two or more of the plurality of variables, respectively, and generating a regression model that regresses a property variable or an objective variable by the plurality of terms, the objective variable indicating an output of an objective function that includes the property variable;
generating, based on coefficients of the plurality of terms included in the regression model, at least one or more subgroups that are one or more of the combinations of variables included in at least one or more of the terms, respectively; and
performing search for each of subspaces spanned by the subgroups based on an optimization criterion for the objective function, and generating pieces of first design value data that include values of the plurality of variables for the subspaces.
   Clause 17. A non-transitory computer readable medium having a computer program stored therein which causes a computer to perform processes comprising:
combining two or more of a plurality of variables and generating a plurality of terms that include combinations of two or more of the plurality of variables, respectively, and generating a regression model that regresses a property variable or an objective variable by the plurality of terms, the objective variable indicating an output of an objective function that includes the property variable;
generating, based on coefficients of the plurality of terms included in the regression model, at least one or more subgroups that are one or more of the combinations of variables included in at least one or more of the terms, respectively; and
performing search for each of subspaces spanned by the subgroups based on an optimization criterion for the objective function, and generating pieces of first design value data that include values of the plurality of variables for the subspaces.

1. An information processing apparatus comprising:
a regression model generator configured to, by combining two or more of a plurality of variables, generate a plurality of terms that include combinations of two or more of the plurality of variables, respectively, and generate a regression model that regresses a property variable or an objective variable by the plurality of terms, the objective variable indicating an output of an objective function that includes the property variable;
a subgroup generator configured to generate, based on coefficients of the plurality of terms included in the regression model, at least one or more subgroups that are one or more of the combinations of variables included in at least one or more of the terms, respectively; and
a subspace search processor configured to perform search for each of subspaces spanned by the subgroups based on an optimization criterion for the objective function, and generate pieces of first design value data that include values of the plurality of variables for the subspaces.

2. The information processing apparatus according to claim 1, wherein the regression model generator generates the regression model based on data sets, the data sets including pieces of second design value data that include values of the plurality of variables acquired by sampling, respectively, and output values of the property variable or output values of the objective function based on the pieces of second design value data, respectively.

3. The information processing apparatus according to claim 2, wherein the subgroup generator performs selection of the terms in descending order of absolute values of the coefficients and generation of the subgroups that are the combinations of variables included in the terms in order of selection until the plurality of variables are included in at least any of the subgroups.

4. The information processing apparatus according to claim 3, wherein the subspace search processor searches the subspaces in descending order of the absolute values of the coefficients.

5. The information processing apparatus according to claim 1, wherein each of the terms includes at least one of a product of the variables, reciprocals of the variables, a product of the reciprocals of the variables and a compound function of the variables.

6. The information processing apparatus according to claim 1, wherein the regression model generator generates the regression model using at least one of ridge regression, lasso regression, elastic net regression, decision tree regression, random forest regression, K-proximity regression, support vector regression and a neural network.

7. The information processing apparatus according to claim 2, wherein
the subspace search processor decides values of variables other than the variables that span the subspaces among the plurality of variables wherein the decided values are any of the pieces of first design value data or any of the pieces of second design value data that gives an optimal output value of the property variable or the objective function among the output values included in the data sets,
generates the pieces of first design value data that include
the values of the variables acquired by the search and
the value of the other variables and
adds, to the data sets, pieces of data that include
the pieces of first design value data and
values of the property variable or output values of the objective variable based on the pieces of first design value data.

8. The information processing apparatus according to claim 7, wherein the subspace search processor searches a space spanned by any of the subgroups that has the next largest coefficient absolute value based on the data sets to which the pieces of data are added.

9. The information processing apparatus according to claim 7, wherein the subspace search processor continuously performs search of the subspace a plurality of times.

10. The information processing apparatus according to claim 7, wherein, after the search for all the subspaces ends, a series of the processes by the regression model generator, the subgroup generator and the subspace search processor is repeated one or more times based on the data sets.

11. The information processing apparatus according to claim 10, wherein the subgroup generator increases the number of the subgroups to be generated as the number of repetitions of the series of the processes increases.

12. The information processing apparatus according to claim 10, wherein the subgroup generator decreases the number of the subgroups to be generated as the number of repetitions of the series of the processes increases.

13. The information processing apparatus according to claim 10, wherein the subgroup generator changes the number of the subgroups to be generated when the number of repetitions of the series of the processes reaches a predetermined number of times.

14. The information processing apparatus according to claim 1, further comprising an output device configured to output information about the terms and the coefficients of the terms that are included in the regression model.

15. The information processing apparatus according to claim 1, wherein a target apparatus is a semiconductor apparatus.

16. An information processing method comprising:
combining two or more of a plurality of variables and generating a plurality of terms that include combinations of two or more of the plurality of variables, respectively, and generating a regression model that regresses a property variable or an objective variable by the plurality of terms, the objective variable indicating an output of an objective function that includes the property variable;
generating, based on coefficients of the plurality of terms included in the regression model, at least one or more subgroups that are one or more of the combinations of variables included in at least one or more of the terms, respectively; and
performing search for each of subspaces spanned by the subgroups based on an optimization criterion for the objective function, and generating pieces of first design value data that include values of the plurality of variables for the subspaces.

17. A non-transitory computer readable medium having a computer program stored therein which causes a computer to perform processes comprising:
combining two or more of a plurality of variables and generating a plurality of terms that include combinations of two or more of the plurality of variables, respectively, and generating a regression model that regresses a property variable or an objective variable by the plurality of terms, the objective variable indicating an output of an objective function that includes the property variable;
generating, based on coefficients of the plurality of terms included in the regression model, at least one or more subgroups that are one or more of the combinations of variables included in at least one or more of the terms, respectively; and
performing search for each of subspaces spanned by the subgroups based on an optimization criterion for the objective function, and generating pieces of first design value data that include values of the plurality of variables for the subspaces.
